(19) United States
(12) Patent Application Publication
(10) Pub. No.: US 2013/0057808 A1
(43) Pub. Date: Mar. 7, 2013

(54) LIQUID CRYSTAL DEVICE, TEMPERATURE DETECTION METHOD, AND ELECTRONIC APPARATUS

(71) Applicant: SEIKO EPSON CORPORATION, Tokyo (JP)

(72) Inventors: Kazuhisa MIZUSAKO, Chino-shi (JP); Takashi TOYOOKA, Matsumoto-shi (JP)

(73) Assignee: SEIKO EPSON CORPORATION, Tokyo (JP)

(21) Appl. No.: 13/664,879

(22) Filed: Oct. 31, 2012

Related U.S. Application Data
(63) Continuation of application No. 12/710,672, filed on Feb. 23, 2010.

(30) Foreign Application Priority Data
Feb. 25, 2009 (JP) 2009-041923
Dec. 1, 2009 (JP) 2009-273670

(51) Int. Cl. G02F 1/1333

(52) U.S. Cl. 349/72

(57) ABSTRACT

A liquid crystal device including a pair of substrates that are provided opposite to each other with a liquid crystal layer being disposed therebetween, a pair of electrodes provided for each intersection of a plurality of scanning lines and a plurality of data lines, the pair of electrodes driving the liquid crystal layer, a driving circuit that applies a driving voltage to the pair of electrodes, an electric current detection element that detects a value corresponding to an electric current that flows in the liquid crystal layer when the driving voltage is applied, and a temperature information output circuit that outputs temperature information of the liquid crystal layer based on the value corresponding to the electric current.

This application is a Continuation of U.S. application Ser. No. 12/710,672, filed Feb. 23, 2010, which claims priority to Japanese No. 2009-041923, filed Feb. 25, 2009 and 2009-273670, filed Dec. 1, 2009. The foregoing patent applications are incorporated herein by reference.

### BACKGROUND

1. Technical Field

The present invention relates to a technique for detecting the temperature of a liquid crystal layer with greater accuracy.

2. Related Art

The response speed of liquid crystal in a liquid crystal panel changes depending on the temperature. A delayed response speed results in a degradation in display quality. To address this problem, one method currently known in the art uses a temperature sensor located near the liquid crystal panel to detect the temperature and performs various control operations based on the detected temperature. An example of such a technique is disclosed in FIG. 2 of Japanese Patent Document JP-A-9-96796.

One problem with this configuration, however, is that although a temperature sensor is capable of detecting temperature near the liquid crystal panel, it cannot detect temperature in the liquid crystal layer of the liquid crystal panel. For this reason, temperature detected by a temperature sensor is susceptible to measurement error as compared with actual temperature in the liquid crystal layer of a liquid crystal panel. This measurement error often makes it difficult to perform various control operations accurately. In addition, in order for the temperature sensor to work properly, the sensor needs to be provided at a position where it is not susceptible to effects of ambient temperature. This has become increasingly difficult as user demands for a display device that is small in size and has a narrow frame area has increased, resulting in a limited amount of space where a temperature sensor can be mounted.

### BRIEF SUMMARY OF THE INVENTION

An advantage of some aspects of the invention is to provide a technique for detecting the temperature of the liquid crystal layer of a liquid crystal panel with greater accuracy free and free from mounting restrictions.

A first aspect of the invention is a liquid crystal device which includes a pair of substrates that are provided opposite to each other with a liquid crystal layer being disposed therebetween, a pair of electrodes provided for each intersection of a plurality of scanning lines and a plurality of data lines which drive the liquid crystal layer, a driving circuit that applies a driving voltage to the pair of electrodes, an electric current detection element that detects a value corresponding to an electric current that flows in the liquid crystal layer when the driving voltage is applied, and a temperature information output circuit that outputs temperature information of the liquid crystal layer based on the value corresponding to the electric current.

The specific resistance of the liquid crystal layer decreases as temperature increases. According to the first aspect of the invention, temperature information is outputted utilizing this change in resistance. By this means, it is possible to detect the temperature of the liquid crystal layer. Since the only thing required is to detect a value corresponding to an electric current that flows in a liquid crystal layer, a position where an electric current detection element can be mounted is less limited.

A second aspect of the invention is a liquid crystal device including first substrate and a second substrate that are provided opposite to each other with a liquid crystal layer being disposed therebetween, a first electrode and a second electrode provided for each intersection of a plurality of scanning lines and a plurality of data lines, which drive the liquid crystal layer, a first supply circuit that supplies a first voltage to the first electrode through an electric supply line, a second supply circuit that supplies a second voltage to the second electrode through the data line, where the second voltage is different from the first voltage, an electric current detection element that includes a resistance element that is inserted on the electric supply line, for detecting a value corresponding to an electric current that flows in the liquid crystal layer when the first voltage and the second voltage are applied, and a temperature information output circuit that outputs temperature information of the liquid crystal layer based on the value corresponding to the electric current.

Besides these two liquid crystal devices, the concept of the invention also encompasses a temperature detection method and an electronic apparatus that are provided with the liquid crystal devices of the first and second aspects of the invention.

### BRIEF DESCRIPTION OF THE DRAWINGS

The invention will be described with reference to the accompanying drawings, wherein like numbers reference like elements.

FIG. 1 is a diagram that schematically illustrates an example of the configuration of a liquid crystal display device according to a first embodiment of the invention;

FIG. 2A is a perspective view that schematically illustrates an example of the configuration of a liquid crystal panel of a liquid crystal display device according to the first embodiment of the invention;

FIG. 2B is a sectional view taken along the line IIB-IIB of FIG. 2A;

FIG. 3 is a diagram that schematically illustrates an example of the configuration of pixels of the liquid crystal display device;

FIG. 4A-4b are graphs that show an example of a relationship between current and temperature in the liquid crystal display device;

FIG. 5 is a diagram that schematically illustrates an example of the display operation of the liquid crystal display device;

FIG. 6 is a diagram that schematically illustrates an example of the temperature detection operation (A) of the liquid crystal display device;

FIG. 7 is a diagram that schematically illustrates an example of the temperature detection operation (B) of the liquid crystal display device;

FIG. 8A is a flowchart that schematically illustrates an example of the temperature detection operation (B) with detection of a current saturation value;

FIG. 8B is a flowchart that schematically illustrates an example of the temperature detection operation (B) with detection of a second peak value;

FIG. 8C is a flowchart that schematically illustrates an example of the temperature detection operation (B) with detection of arrival time;

FIG. 9 is a diagram that schematically illustrates an example of the configuration of a liquid crystal display device according to a second embodiment of the invention;

FIG. 10 is a diagram that schematically illustrates an example of the temperature detection operation (C) of the liquid crystal display device;

FIG. 11 is a diagram that schematically illustrates an example of the configuration of a liquid crystal display device according to a third embodiment of the invention;

FIG. 12A is a graph that shows an example of a relationship between relative transmittance and gradation in the liquid crystal display device;

FIG. 12B is a graph that shows an example of a relationship between relative transmittance and voltage applied in the liquid crystal display device;

FIG. 12C is a table that shows an example of a relationship between gradation and voltage applied in the liquid crystal display device; and

FIG. 13 is a diagram that schematically illustrates an example of the configuration of a projector, which is an example of a apparatus to which the liquid crystal display device of the invention may be applied.

### DESCRIPTION OF EXEMPLARY EMBODIMENTS

### First Embodiment

With reference to the accompanying drawings, exemplary embodiments of the present invention will now be explained in detail.

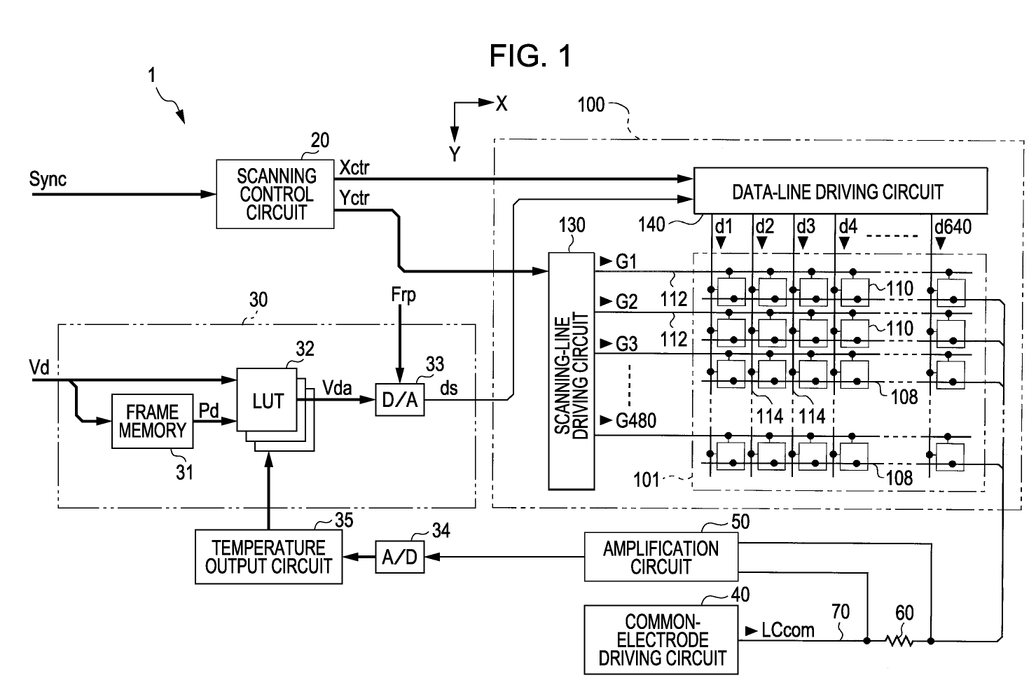

FIG. 1 is a diagram that schematically illustrates an example of the configuration of a liquid crystal display device according to a first embodiment of the invention. A liquid crystal display device 1 according to the first embodiment of the invention switches from one lookup table to another depending a detected temperature. The lookup tables are used for compensating for the responsiveness of liquid crystal. The liquid crystal display device 1 is characterized by the output of temperature information. As illustrated in FIG. 1, the liquid crystal display device 1 includes a scanning control circuit 20, a data processing circuit 30, an analog-to-digital (A/D) conversion circuit 34, a temperature output circuit 35, a common-electrode driving circuit 40, an amplification circuit 50, a resistance element 60, and a liquid crystal panel 100. The common-electrode driving circuit 40 is an example of a first supply circuit according to an aspect of the invention. The data processing circuit 30 is an example of a second supply circuit according to an aspect of the invention. A video signal Vd is supplied from an upstream host circuit to the liquid crystal display device 1 in synchronization with a sync signal Sync. The video signal Vd is digital data for specifying a gradation level (i.e., tone level) for each pixel of the liquid crystal panel 100. The video signal Vd is supplied in the sequential order of pixels scanned on the basis of a vertical scanning signal, a horizontal scanning signal, and a dot clock signal (not shown), which are contained in the sync signal Sync.

The liquid crystal panel 100 is, for example, an active-matrix transmissive liquid crystal panel. Four hundred eighty scanning lines 112 and six hundred forty data lines 114 are formed in the display area of the liquid crystal panel 100. Each scanning line 112 extends in the X (horizontal) direction as a row shown in the drawing. Each data line 114 extends in the Y (vertical) direction as a column shown in the drawing. The scanning lines 112 and the data lines 114 are electrically isolated from each other. A pixel 110 is formed at a position corresponding to each of the intersections of the scanning lines 112 and the data lines 114. Accordingly, in the present embodiment of the invention, the pixels 100 are arrayed in a matrix of four hundred eighty rows and six hundred forty columns. The areas where the pixels 110 are formed constitute a display area 101.

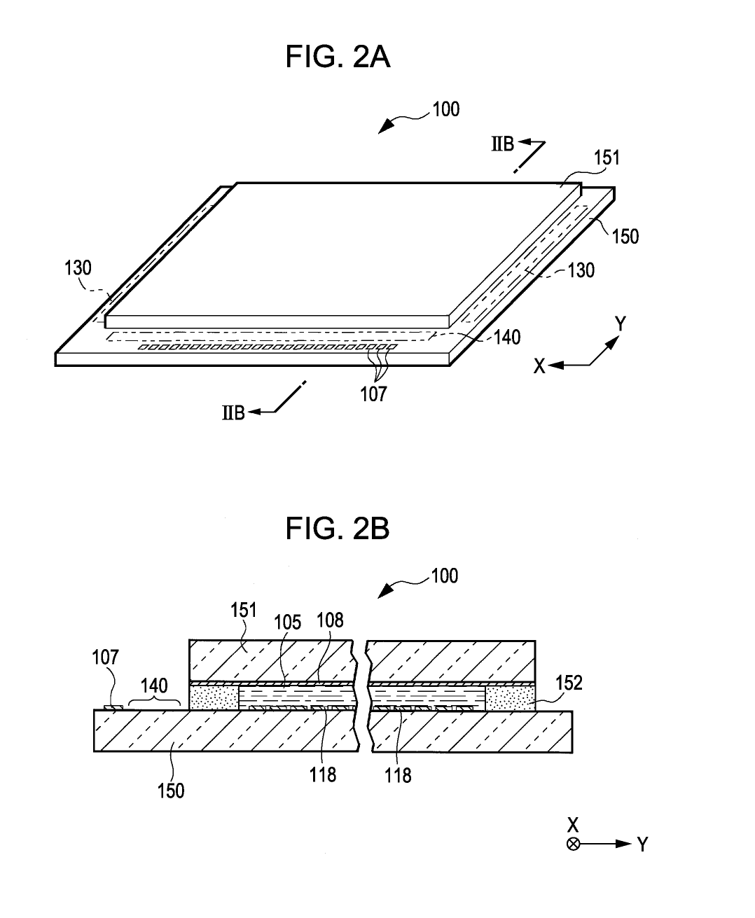

FIG. 2A is a perspective view that schematically illustrates an example of the configuration of the liquid crystal panel 100 according to an exemplary embodiment of the invention. FIG. 2B is a sectional view taken along the line IIB-IIB of FIG. 2A. As illustrated in these drawings, the liquid crystal panel 100 includes a TFT array substrate 150 (a first substrate) and an opposite substrate 151 (a second substrate). The TFT array substrate 150 and the opposite substrate 151 are bonded to each other by means of a sealing material (i.e., sealant) 152. Pixel electrodes 118, various kinds of wiring, and the like are formed on the TFT array substrate 150. A common electrode 108 is formed on the opposite substrate 151. The electrode formation surface of the TFT array substrate 150 and the electrode formation surface of the opposite substrate 151 face each other. When viewed in plan in a direction which is normal to the substrate, the sealing material 152 is applied in the shape of a frame along the sides of the opposite substrate 151. The sealing material 152 fixes the substrates 150 and 151 to each other with a certain gap being left therebetween. Liquid crystal is sealed in the gap to form a liquid crystal layer 105. A scanning-line driving circuit 130 and a data-line driving circuit 140 are provided at a peripheral circuit area outside the sealing material 152 over the TFT array substrate 150. A plurality of terminals 107 is formed at an edge area near the data-line driving circuit 140 over the TFT array substrate 150. Signals and the like that have been outputted from the scanning control circuit 20 and the data processing circuit 30 are inputted into the liquid crystal panel 100 via the terminals 107. In the example shown in FIG. 2A, the scanning-line driving circuit 130 is provided at two opposite edge areas, more specifically, peripheral areas along two opposite sides each of which extends in the Y direction. Accordingly, the scanning lines 112 are driven from both sides. However, the scope of the invention is not limited to this configuration and other configurations may be used without departing from the meaning or scope of the invention. For example, if the delay and distortion of scanning signals supplied through the scanning lines 112 are negligible and/or do not matter, a scanning-line driving circuit 5 (130) may be provided at one edge area only. Whichever configuration is used, the circuit is considered to be equivalent to the single scanning-line driving circuit shown in FIG. 1.

The scanning control circuit 20, the data processing circuit 30, the A/D conversion circuit 34, the temperature output circuit 35, the common-electrode driving circuit 40, and the amplification circuit 50 may be configured as a module and connected to the terminals 107 of the liquid crystal panel 100 via a flexible printed circuit (FPC). The resistance element 60 and an electric supply line (i.e., feeder wire) 70 may be included in the FPC. Among the above components, the data processing circuit 30, the A/D conversion circuit 34, the temperature output circuit 35, the common-electrode driving circuit 40, the amplification circuit 50, and the resistance element 60 may be provided at a peripheral circuit area outside the sealing material 152 over the TFT array substrate 150.

Regardless of whether the resistance element 60 is included in the FPC or provided at a peripheral circuit area, it is preferable that the resistance element 60 be provided at an area outside the sealing material 152 in the structure of the liquid crystal panel 100. Otherwise, if the resistance element 60 is provided at an area inside the sealing material 152, the temperature of the liquid crystal layer 105 changes locally when the resistance element 60 generates heat. Accordingly, there is a risk that such a local temperature change affects display or that irregularities formed by heat affects the orientation of liquid crystal.

By placing the resistance element 60 in an area outside the sealing material 152, it is possible to avoid such a risk. In an exemplary configuration in which the resistance element 60 is provided at an area outside the sealing material 152, such that the resistance element 60, which is a heating element, is not directly in contact with the liquid crystal layer 105. Therefore, there is no risk of having an influence on the liquid crystal layer 105 and causing deterioration in display quality or the like.

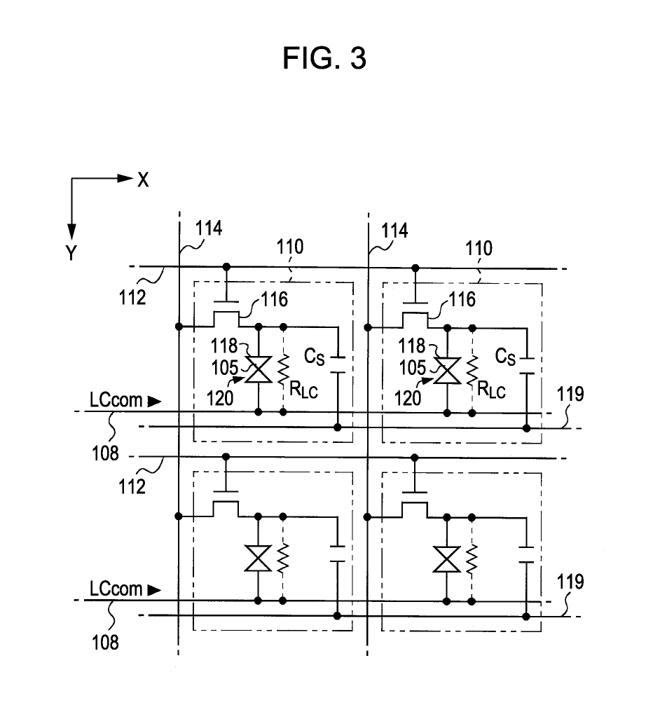

Next, the pixel 110 will be described with reference to FIG. 3. As illustrated in FIG. 3, the pixel 110 includes a thin film transistor (hereinafter abbreviated as “TFT”) 116 and a liquid crystal element 120. The TFTs 116, the scanning lines 112, the data lines 114, and the pixel electrodes 118 are formed at one surface side of the TFT array substrate 150, that is, the surface that faces toward the opposite electrode 151. The source electrode of the TFT 116 is connected to the data line 114. The drain electrode of the TFT 116 is connected to the pixel electrode 118. The gate electrode of the TFT 116 is connected to the scanning line 112. The liquid crystal layer 105 is disposed between the TFT array substrate 150 and the opposite substrate 151 with the electrode formation surface of the TFT array substrate 150 and the electrode formation surface of the opposite substrate 151 facing each other as previously explained. Accordingly, the liquid crystal layer 105 is disposed between the common electrode 108 and the pixel electrodes 118. These components/elements make up the liquid crystal element 120. The common electrode 108 is an example of a first electrode according to an aspect of the invention. The pixel electrode 118 is an example of a second electrode according to an aspect of the invention. Therefore, the liquid crystal element 120 that includes the pixel electrode 118, the common electrode 108, and the liquid crystal layer 105 is formed for each pixel 110.

The pixel electrode 118 is provided for each of the pixels 110 whereas the common electrode 108 is, as its name indicates, provided as an electrode that is common to all of the pixels 110. The common electrode 108 faces the pixel electrodes 118. The common-electrode driving circuit 40 applies a voltage LCcom, which is an example of a first voltage according to an aspect of the invention, to the common electrode 108. The liquid crystal element 120 having the above configuration holds a voltage between the common electrode 108 and the pixel electrode 118. If the liquid crystal panel 100 is a transmissive panel, its transmission factor depends on the effective value of the voltage at which the liquid crystal panel 100 is held.

A resistance R_{LC} shown by a broken line in FIG. 3 denotes the resistance component of the liquid crystal layer 105 in the liquid crystal element 120. The pixel 110 includes an auxiliary capacitance C_{S}. One end of the auxiliary capacitance C_{S} is connected to the pixel electrode 118. The other end of the auxiliary capacitance C_{S} is connected in common to an auxiliary capacitance electrode 119.

Referring back to FIG. 1, in the liquid crystal panel 100, the scanning-line driving circuit 130 and the data-line driving circuit 140 are provided at a peripheral area outside the display area 101. In accordance with a control signal Yctr supplied from the scanning control circuit 20, the scanning-line driving circuit 130 supplies scanning signals G1-G480 to the first to four hundred eightieth scanning lines 112, respectively. In accordance with a control signal Xctr supplied from the scanning control circuit 20, the data-line driving circuit 140 supplies data signals ds to the respective pixels 110 on the row selected by the scanning-line driving circuit 130 through the first to six hundred fortieth data lines 114. The data signals that are supplied to the first to 640th data lines 114 are shown as d1-d640, respectively.

The common-electrode driving circuit 40 applies the voltage LCcom to the common electrode 108 through the electric supply line 70. The resistance element 60 is an electric current detection element that is provided somewhere on the electric supply line 70. The amplification circuit 50 amplifies a voltage that is generated between the terminals of the resistance element 60 with an amplification coefficient α.

The A/D conversion circuit 34 (shown as A/D) converts the voltage outputted from the amplification circuit 50 into a digital value at a predetermined sampling rate. The temperature output circuit 35 outputs information on the temperature of the liquid crystal layer 105 in the liquid crystal panel 100 on the basis of the converted digital value.

The data processing circuit 30 compensates the video signal Vd in accordance with the information on the detected temperature and outputs a processing result as the data signal ds. The data processing circuit 30 includes a frame memory 31, a lookup table 32 (shown as LUT), and a digital-to-analog conversion circuit 33 (shown as D/A).

The frame memory 31 temporarily stores the video signal Vd. After the lapse of one frame, the frame memory 31 reads out the video signal and then outputs it as a preceding video signal Pd. Therefore, when the video signal Vd for a certain pixel is supplied in synchronization with the sync signal Sync from a host circuit, the preceding video signal Pd, which is a video signal for this pixel for the preceding frame, is read out and outputted from the frame memory 31. The term “frame” means a period of time that is required for supplying the video signal Vd for one picture of an image. For example, if the frequency of a vertical scanning signal included in the sync signal Sync is 60 Hz, the frame is its inverse number, that is, 16.7 milliseconds. In a case where the liquid crystal panel 100 is driven at the same speed as the supply speed of the video signal Vd, the frame is equivalent to a period of time that is required for displaying one picture of an image on the liquid crystal panel 100.

The lookup table 32 is used for performing so-called overdrive conversion for compensating for the varying responsiveness of liquid crystal. In the present embodiment of the invention, there are three types of lookup tables, that is, a low temperature range lookup table, a normal mid temperature range lookup table, and a high temperature range lookup table. A lookup table for a certain temperature range is a two-dimensional table that pre-stores an optimum compensation video signal Vda in the temperature range for each combination of a gradation level specified by the video signal Vd and a gradation level specified by the video signal Pd of the preceding frame. Accordingly, when the video signals Vd and Pd are inputted therein, the compensation video signal Vda corresponding to a combination of gradation levels specified by these two signals are read out of the lookup table. The selection of a lookup table among the three temperature types of tables is made as follows, depending on temperature information outputted from the temperature output circuit 35. When the value of the temperature information outputted from the temperature output circuit 35 is not larger than a threshold T1, the low temperature range lookup table is selected. When the value of the temperature information outputted from the temperature output circuit 35 is larger than the threshold T1 and not larger than a threshold T2, the normal temperature range lookup table is selected. When the value of the temperature information outputted from the temperature output circuit 35 is larger than the threshold T2, the high temperature range lookup table is selected.

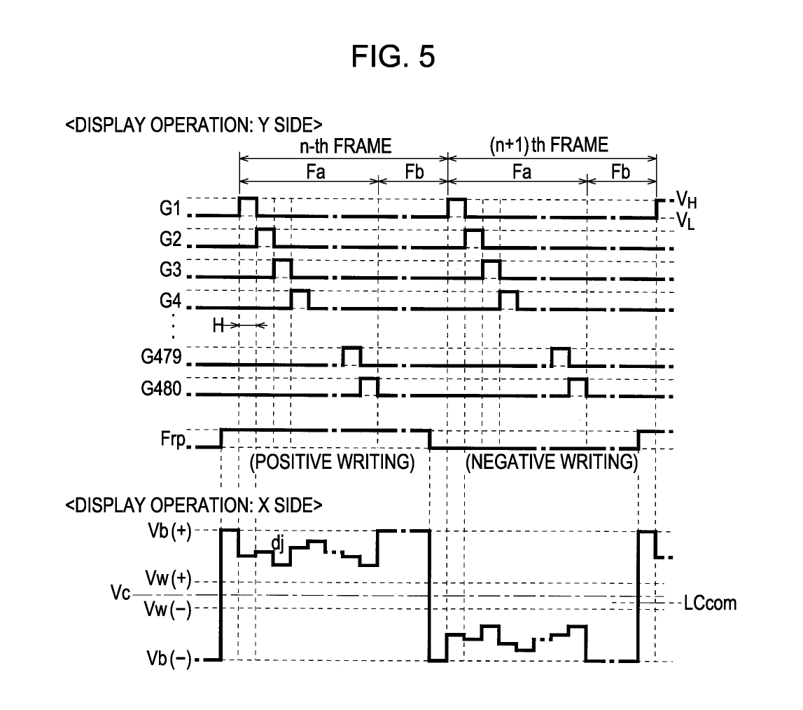

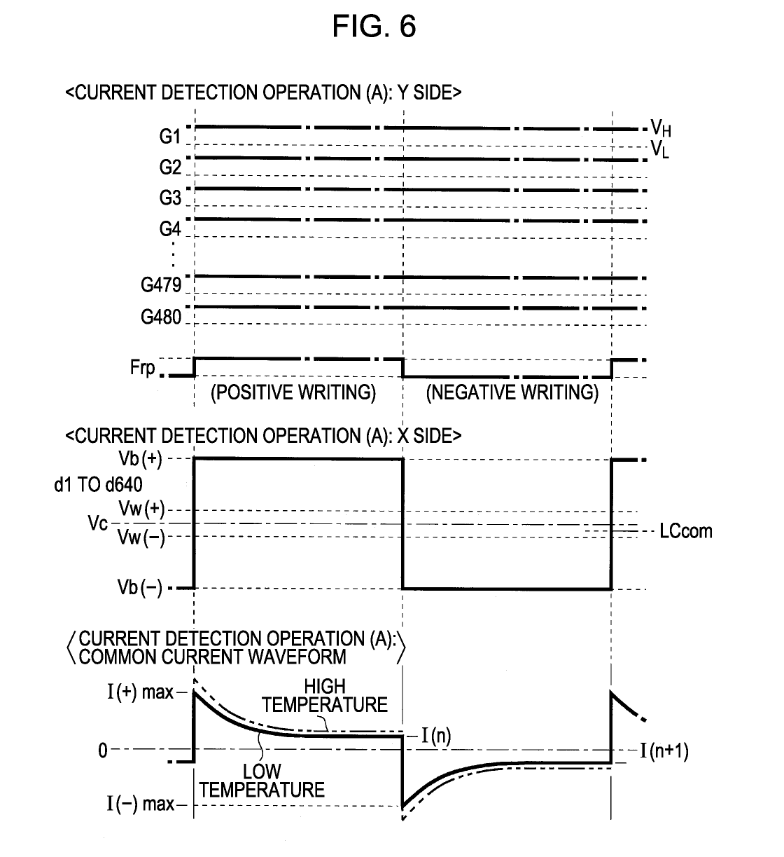

The D/A conversion circuit 33 converts the compensation video signal Vda outputted from the lookup table 322 into an analog voltage signal whose polarity is specified by a signal Frp. The D/A conversion circuit 33 outputs the signal subjected to conversion as the data signal ds. Regarding the polarity of the data signal ds, the side where a voltage level is higher than the level of a video amplitude center voltage (i.e., reference voltage) Vc is taken as a positive polarity side, whereas the side where a voltage level is lower than the level of the video amplitude center voltage Vc is taken as a negative polarity side. The signal Frp specifies positive polarity when it is in the high level H. The signal Frp specifies negative polarity when it is in the low level L. The signal Frp is supplied from the scanning control circuit 20. For example, the signal Frp has a pulse waveform as illustrated in FIGS. 5 and 6. As shown therein, its logic level inverts for each time period corresponding to a frame.

Next, the operation of the liquid crystal display device 1 according to the present embodiment of the invention is explained. With reference to FIG. 5, the display operation of the liquid crystal display device 1 will be explained. In FIG. 5, it is assumed that positive-polarity writing is specified in an n-th frame. In the next frame (n+1), it is assumed that negative-polarity writing is specified. Each frame includes a vertical effective scanning time period Fa and a vertical flyback time period Fb. Throughout the vertical effective scanning time period Fa, the video signal Vd is supplied from the host circuit sequentially to the pixels in the following order: the first to the 640th pixels on the first row, the first to the 640th pixels on the second row, the first to the 640th pixels on the third row, etc., with the first to the 640th pixels on the 480th row. The logic level of the signal Frp switches over at a predetermined point in time during the vertical flyback time period Fb.

In the horizontal scanning time period (H) in which the video signal Vd is supplied to the first to the 640th pixels on the first row, the scanning-line driving circuit 130, which is controlled by the scanning control circuit 20, sets the level of the scanning signal G1 at the H level. The data processing circuit 30 converts the video signal Vd into the data signal ds having positive polarity in the n-th frame. The data-line driving circuit 140 samples the data signal ds on the first to 640th data line 114 as the data signals d1-d640, respectively, as controlled by the scanning control circuit 20. When the level of the scanning signal G1 is set at the H level, the TFTs 116 on the first row are set in an ON state. Accordingly, the data signals sampled on the data lines 114 are applied to the pixel electrodes 118 through the TFTs 116 set ON. Therefore, a positive voltage with responsiveness compensated in accordance with a gradation change is written into each of the first to 640th liquid crystal elements 120 on the first row.

In the horizontal scanning time period H in which the video signal Vd is supplied to the pixels on the second row, the scanning-line driving circuit 130 sets the level of the scanning signal G2 at the H level. The data-line driving circuit 140 samples the data signal ds converted from the video signal Vd corresponding to the pixels on the second row on the first to 640th data lines 114. Since the TFTs 116 on the second row are set in an ON state, the data signals sampled on the data lines 114 are applied to the pixel electrodes 118 through the TFTs 116. Therefore, a positive voltage with responsiveness compensated in accordance with a gradation change is written into each of the first to 640th liquid crystal elements 120 on the second row.

The same operation is performed for the third and fourth rows, continuing to the 480th row. As a result, a positive voltage with responsiveness compensated in accordance with a gradation change is written into each of liquid crystal elements on each of these rows. In this way, a transmissive image in the n-th frame is created. In the next (n+1)th frame, since the logic level of the signal Frp is inverted, the video signal Vd has negative polarity. Except for the difference in polarity, the same writing operation as that of the n-th frame is performed. As a result, a negative voltage with responsiveness compensated in accordance with a gradation change is written into each liquid crystal element. In this way, a transmissive image in the (n+1)th frame is created.

In FIG. 5, the voltage LCcom, which is applied to the common electrode 108, is offset at a slightly lower level than the reference voltage Vc, which is the video amplitude center voltage. When the TFT 116 switches from ON to OFF, a field-through phenomenon (push-down, overrun) occurs at the moment of switchover to decrease the voltage at the drain electrode thereof and thus at the pixel electrode 118.

The offset explained above is set for this reason. More specifically, if the voltage LCcom coincides with the reference voltage Vc of an amplitude, the effective value of a voltage applied to a liquid crystal element at the negative polarity side would be larger than that at the positive polarity side because of a field-through phenomenon. The voltage LCcom is set at a lower level in order to offset this effect. The H level for the scanning signals G1 to G480 is a selection voltage V_{H}. The L level for the scanning signals G1 to G480 is a non-selection voltage V_{L}.

In FIG. 5, a data signal dj that is supplied to the data line on the j-th column (where j is an integer that satisfies the mathematical formula of 1≦j≦640) is also shown. If it is assumed that the liquid crystal element 120 according to the present embodiment of the invention is driven in a “normally white” mode, the level of the data signal dj changes at the positive polarity side within a range from a low voltage Vw(+), which is a white level, to a high voltage Vb(+), which is a black level. In addition, in the normally white mode, the level of the data signal dj changes at the negative polarity side in a mirrored range that is symmetric to the positive voltage range with respect to the reference voltage Vc. That is, the data signal dj fluctuates at the negative polarity side within a range from a high voltage Vw(−), which is a white level, to a low voltage Vb(−), which is a black level. The level of the data signal dj is set at the voltage Vb(+), Vb(−) throughout the vertical flyback time period Fb for black-level display. This is because, for example, data written therein due to a timing shift or other reason should not contribute to display.

Next, with reference to FIG. 6, the temperature detection operation of the liquid crystal display device 1 will be explained. The temperature detection operation is performed when, for example, the host circuit issues an instruction for carrying out the operation to the scanning control circuit 20. Or, the temperature detection operation is performed when a spontaneous instruction is generated at and by the scanning control circuit 20. An example of cases where the host circuit issues an instruction for carrying out the temperature detection operation to the scanning control circuit 20 is the issuance of an instruction to switch display to a different menu screen when hierarchical menu screens are displayed. Examples of cases where a spontaneous instruction is generated at and by the scanning control circuit 20 are initial operation immediately after power activation, regular operation at a fixed cycle (e.g., 30 minutes), or the like. In the following description, three types of temperature detection operation are explained. To distinguish one illustrated in FIG. 6 from the others, it is hereinafter referred to as “temperature detection operation (A)”.

When the temperature detection operation (A) is performed, the scanning control circuit 20 controls the scanning-line driving circuit 130 in such a way as to set the level of all of the scanning signals G1 to G480 at the H level. As a result, all TFTs 116 that are arranged in the display area 101 are set ON. On the other hand, the scanning control circuit 20 controls the data-line driving circuit 140 in such a way as to switch the level of the data signals d1 to d640 between the positive voltage Vb(+) corresponding to the black level and the negative voltage Vb(−) corresponding to the black level irrespective of the data signals ds. Attention is focused herein on the time period throughout which the level of the data signals d1 to d640 is set at the voltage Vb(+). In this time period, the voltage Vb(+) is applied to the pixel electrodes 118 in all of the liquid crystal elements 120. On the other hand, the voltage LCcom is applied to the common electrode 108.

Note that it is not necessary take the effects of a field-through phenomenon, off-leak, and the like into consideration in the temperature detection operation (A) because the level of all of the scanning signals G1 to G480 is set at the H level therein. For this reason, the voltage level of the common electrode 108 may be set at the same level as the reference voltage Vc, which is the video amplitude center voltage.

As explained above, at the liquid crystal element 120, the voltage LCcom (or the voltage Vc) is applied to the common electrode 108 whereas the voltage Vb(+), which is relatively high, is applied to the pixel electrode 118. Therefore, an electric current flows in a direction from the pixel electrode 118 toward the common electrode 108 through the resistance component R_{LC} of the liquid crystal layer 105. Therefore, a voltage is generated between the terminals of the resistance element 60 that is provided on the electric supply line 70 through which the voltage LCcom is supplied. The voltage that is generated therebetween has a value that is equal to the product of the sum of the values of an electric current that flows in the liquid crystal layer 105 of all of the liquid crystal elements 120 and a value of resistance R of the resistance element 60. The amplification circuit 50 amplifies the voltage generated between the terminals of the resistance element 60 with the amplification coefficient a. Thereafter, the A/D conversion circuit 34 converts the amplified voltage into a digital value. A transient current flows in the liquid crystal layer 105 due to charge and discharge immediately after the application of the voltage Vb(+) to the pixel electrodes 118 with the setting of the level of the data signals d1 to d640 at the voltage Vb(+).

For this reason, the waveform of an electric current that flows through the electric supply line 70 (i.e., common current waveform) is as shown in FIG. 6. At a point in time where the level of the data signals d1 to d640 switches to the voltage Vb(+), it reaches a positive peak value I(+)max. On the other hand, since a detection target of the present embodiment of the invention is an electric current that reflects the resistance component R_{LC}, a preferred point in time at which a voltage generated between the terminals of the resistance element 60 should be sampled is a point in time at which a transient current settles, that is, after the lapse of sufficient time since the switchover of the level of the data signals d1 to d640 to the positive voltage Vb(+). For example, preferred timing is a point in time immediately before the switchover of the level of the data signals d1 to d640 to the negative voltage Vb(−). For this reason, in the present embodiment of the invention, among digital values outputted from the A/D conversion circuit 34 after the A/D conversion is performed, the temperature output circuit 35 uses a value sampled at a point in time immediately before the switchover of the voltage level of the data signals d1 to d640 thereto as a current saturation (settlement) value. In the common current waveform illustrated in FIG. 6, the point of zero is important.

If a voltage applied to all of the pixel electrodes 118 coincides with the voltage LCcom applied to the common electrode 108, it follows that the value of an electric current that flows through the electric supply line 70 should be zero. In view of the above, a current zero point is taken as follows. Prior to electric current detection operation, the level of all of the scanning signals G1 to G480 is set at the H level. In addition, the level of the data signals d1 to d640 is set at the voltage LCcom for the writing of the voltage LCcom into all of the pixel electrodes 118. Then, after the lapse of sufficient time, the output value of the amplification circuit 50 in a stationary state is used as the current zero point.

As a first step of operation, the temperature output circuit 35 calculates the sum of the values of an electric current that flows in the liquid crystal layer 105 of all of the liquid crystal elements 120 by dividing the voltage converted into a digital value by the resistance value R and the amplification coefficient a. In the electric current subjected to summation, the transient current component is eliminated. The summation value calculated here corresponds to a value denoted as I(n) in the common current waveform (as shown in FIG. 6).

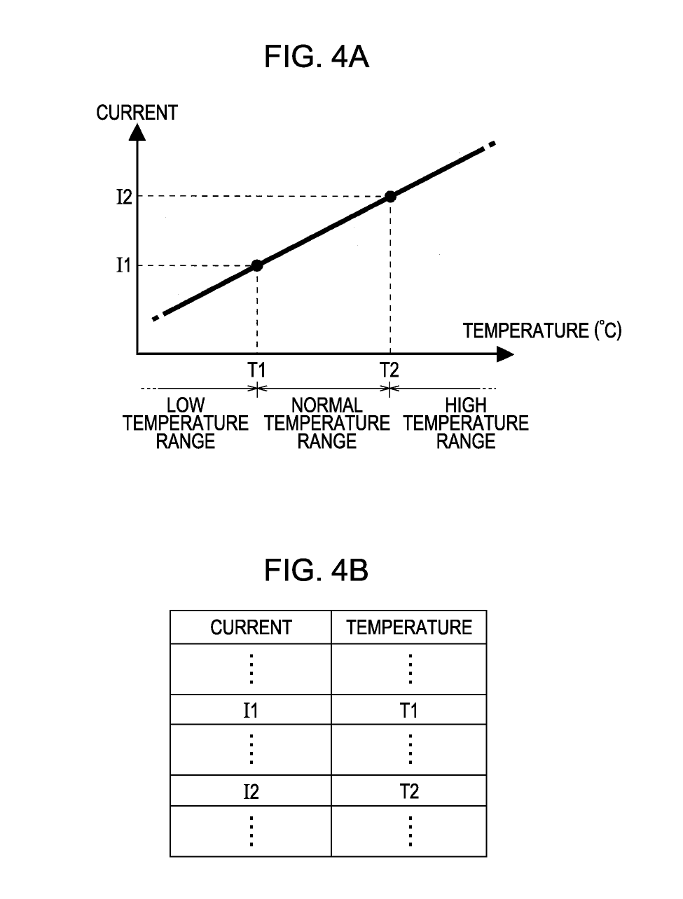

The liquid crystal layer 105 has characteristics that resemble those of a semiconductor in that the specific resistance of the liquid crystal layer 105 decreases as the temperature increases and that the specific resistance thereof increases as the temperature decreases. For this reason, the summation value of an electric current that flows in the liquid crystal layer 105 increases almost in proportion to an increase in temperature. Specifically, the common current waveform has characteristics at a low temperature which are shown by the solid line shown in FIG. 6. By way of comparison, the common current waveform has characteristics at a high temperature which are shown by a two-dot chain line. Therefore, through the utilization of such characteristics, it is possible to calculate the temperature of the liquid crystal layer 105 based on the summation value of an electric current. In the present embodiment of the invention, for the liquid crystal layer 105 in the liquid crystal panel 100, the relationship between the summation value of an electric current and temperature as illustrated in FIG. 4A has been experimentally determined, or determined by other means, in advance. In addition, information on the found characteristics (e.g., inclination, intercept) is pre-stored in the temperature output circuit 35. As a second step of operation, the temperature output circuit 35 utilizes the characteristic information to calculate temperature from the calculated sum of the values of an electric current. Then, the temperature output circuit 35 outputs the calculated temperature.

If the voltage Vb(+) continued to be applied to the pixel electrode 118, a direct-current component would be applied to the liquid crystal layer 105. In order to avoid the application of a direct-current component thereto, the data-line driving circuit 140 switches the level of the data signals d1 to d640 to the negative voltage Vb(−) corresponding to the black level as illustrated in FIG. 6. Since an electric current has already been detected during a time period throughout which the level of the data signals d1 to d640 is set at the positive voltage Vb(+), it is not necessary to detect an electric current during a time period throughout which the level of the data signals d1 to d640 is set at the negative voltage Vb(−). Though it is not necessary, a current value I(n+1) obtained when the level of the data signals d1 to d640 is set at the voltage Vb(−) may be detected in addition to the detection of the current value I(n) obtained when the level of the data signals d1 to d640 is set at the voltage Vb(+), followed by the calculation of temperature based on the average of the absolute values of the two. By this means, it is possible to reduce an error.

At the lookup table 32, a table for a temperature range within which a temperature (temperature information) outputted falls is selected from the temperature output circuit 35. Since an appropriate lookup table (32) is selected in accordance with the temperature of the liquid crystal layer 105 in the liquid crystal panel 100, the present embodiment of the invention makes it possible to improve the display characteristics of a moving picture changes depending on the temperature.

The level of an electric current that flows in the liquid crystal layer 105 of each individual element is very low, which is not high enough to carry out individual measurement. In the temperature detection operation (A), however, the sum of the values of an electric current that flows in all of the pixels 110 is detected with the setting of the level of the scanning signals G1 to G480 at the H level and the setting of the level of the data signals d1 to d640 at the positive voltage Vb(+) corresponding to the black level. Therefore, it is possible perform a measurement. In addition, in the temperature detection operation (A), since the level of the data signals ds is set at the voltage Vb(+) corresponding to the black level, that is, the maximum level when the TFTs 116 are set ON, effects due to the temperature dependency of the TFTs 116 can be reduced, thereby making it possible to detect an electric current with higher precision.

It is explained above that the temperature output circuit 35 utilizes characteristic information in the temperature detection operation (A) to calculate temperature information on the basis of the calculated sum of the values of an electric current. However, the scope of the invention is not limited to such an exemplary configuration. For example, as illustrated in FIG. 4B, temperature information relative to each summation value of an electric current may be pre-stored in a table. In this modified configuration, the temperature output circuit 35 looks up the table to find temperature information corresponding to the summation value of an electric current and then outputs the found value. Since the temperature output circuit 35 uses the table to output temperature information, it is not necessary to perform computation at the temperature output circuit 35, which makes it possible to simplify configuration.

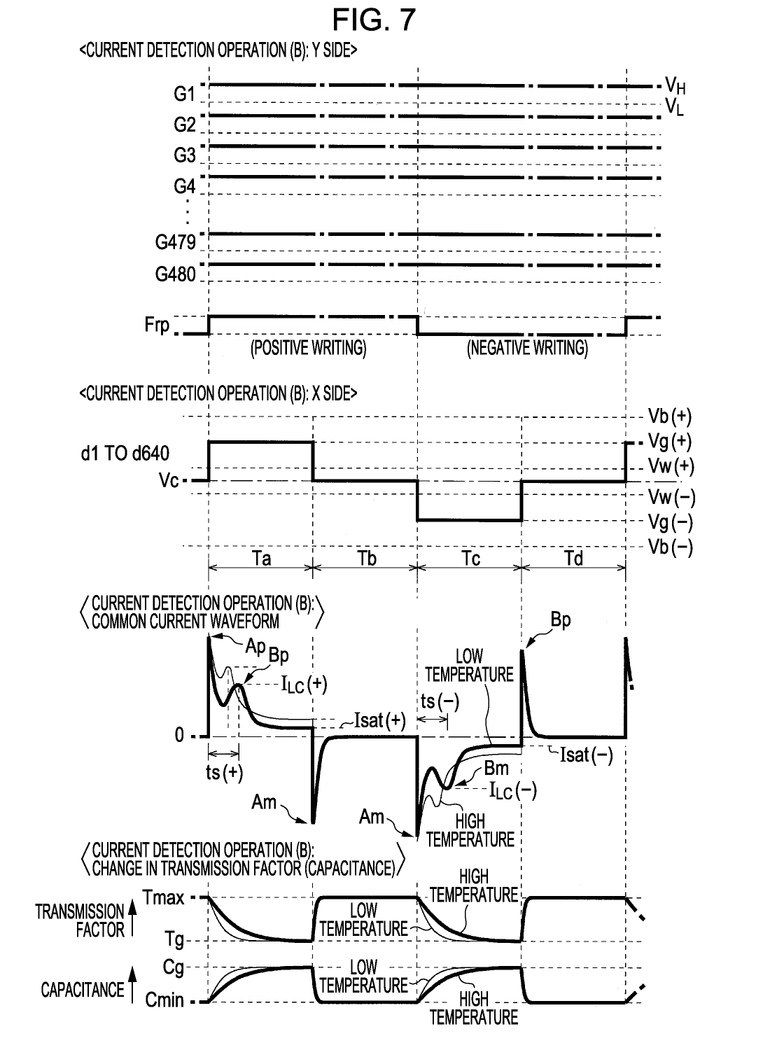

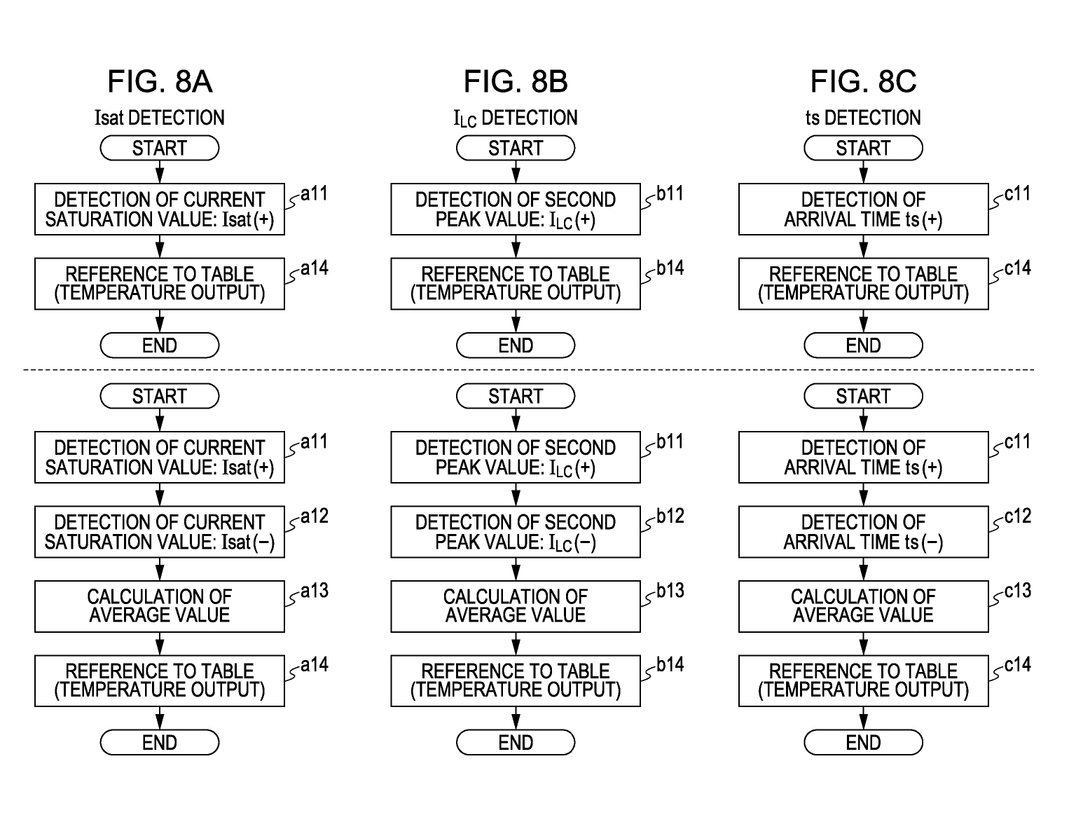

Next, with reference to FIGS. 7 and 8, the temperature detection operation (B) will be explained. The temperature detection operation (B) is another mode of temperature detection. FIG. 7 is a diagram that schematically illustrates an example of the waveform of signals obtained when the temperature detection operation (B) according to the present embodiment of the invention is performed. When the temperature detection operation (B) is performed, as illustrated in FIG. 7, the scanning control circuit 20 controls the scanning-line driving circuit 130 in such a way as to set the level of all of the scanning signals G1 to G480 at the H level as done in the temperature detection operation (A) explained above. As a result, all TFTs 116 that are arranged in the display area 101 are set ON. In the temperature detection operation (B), the scanning control circuit 20 performs control in a cycle of split time periods Ta→Tb→Tc→Td→(Ta). As such, the scanning control circuit 20 sends a notification that indicates that the time period is one of Ta, Tb, Tc, and Td, to the data-line driving circuit 140 by means of the control signal Xctr. In addition, the scanning control circuit 20 controls the data-line driving circuit 140 in such a way as to set the level of the data signals d1 to d640 at a positive halftone voltage Vg(+) throughout the time period Ta, at the voltage Vc throughout the time period Tb, at a negative halftone voltage Vg(−) throughout the time period Tc, and at the voltage Vc throughout the time period Td, irrespective of the data signals ds as illustrated in FIG. 7. The voltage Vg(+) is a positive voltage that corresponds to a halftone between white and black. The voltage Vg(−) is a negative voltage that corresponds to a halftone between white and black.

Note that the electric current detection operation (B) is irrelevant to the sync signal Sync. Therefore, the time periods Ta, Tb, Tc, and Td are irrelevant to a vertical scanning signal. Notwithstanding the above, however, they may be switched over in synchronization therewith. For example, they may be switched over in a cycle of a half of that of a vertical scanning signal.

In the temperature detection operation (B), since all of the TFTs 116 that are arranged in the display area 101 are set in an ON state, the same voltage is applied to all of the pixel electrodes 118. The level of the data signals d1 to d640 switches over at each transition between the time periods Ta, Tb, Tc, and Td as illustrated in FIG. 7. As the data-signal voltage that is applied to the pixel electrodes 118 is switched over, an electric current flows in the liquid crystal elements 120. When the electric current flows in the liquid crystal elements 120, an electric current whose level is equal to the sum of the values of the electric current that flows in all of the liquid crystal elements 120 flows through the electric supply line 70. The summation electric current that flows through the electric supply line 70 is converted into a voltage by the resistance element 60. Therefore, a common current waveform may be formed, as illustrated in FIG. 7. The reason is explained in detail below.

In the common current waveform, a first positive peak point Ap of a differential waveform appears at the beginning of the time period Ta due to a transient current that flows in the liquid crystal element 120. That is, the first positive peak point Ap appears due to a level switchover in a direction in which the voltage level of the pixel electrode 118 becomes relatively high with respect to the voltage level of the common electrode 108. Next, a second positive peak point Bp appears after the first positive peak point Ap due to a change in the capacitance of the liquid crystal element 120. In like manner, in the common current waveform, a first negative peak point Am of a differential waveform appears at the beginning of the time period Tc due to a level switchover in a direction in which the voltage level of the pixel electrode 118 becomes relatively low with respect to the voltage level of the common electrode 108. A second negative peak point Bm appears due to a change in the capacitance of the liquid crystal element 120 from the start of the time period Tc.

The first peak point Ap (Am) reflects a transient current that flows due to the charging and discharging of the liquid crystal element 120 as in the electric current detection operation (A). For this reason, a duplicate explanation is omitted here.

A change in the capacitance of the liquid crystal element 120 shown by the second peak point Bp (Bm) is explained below. When the voltage that is applied to the pixel electrode 118 is switched from the voltage Vc to the voltage Vg(+) at the beginning of the time period Ta, a voltage that is applied to the liquid crystal element 120 (i.e., a difference between an electric potential applied to the pixel electrode 118 and an electric potential applied to the common electrode 108) changes instantaneously in response to the switchover of the voltage applied to the pixel electrode 118. In contrast, as illustrated in the drawing, a transmission factor, which is an optical response, changes slowly in response to the switchover of the voltage applied to the pixel electrode 118 (It takes several microseconds or so for a transmission factor to reach a saturation value). Specifically, it changes slowly from the maximum transmittance value Tmax in a normally white mode to a transmittance value Tg that corresponds to a halftone.

The capacitance of the liquid crystal element 120 changes depending on the molecular arrangement state (i.e., tilt) of liquid crystal as a dielectric substance disposed between the pixel electrode 118 and the common electrode 108. The transmission factor is determined depending on the tilt thereof. Therefore, the capacitance of the liquid crystal element 120 changes in relation to the transmission factor of the liquid crystal element 120. Generally, the capacitance of the liquid crystal element 120 increases as a voltage applied thereto increases. Since it is assumed that the liquid crystal element 120 according to the present embodiment of the invention is driven in a normally white mode as explained earlier, the capacitance increases as the transmission factor decreases.

In the liquid crystal element 120, the responsiveness of capacitance (transmission factor) relative to the change in applied voltage improves as the temperature increases. Therefore, when a common current waveform at a low temperature has characteristics shown by a thick line in the drawing, a common current waveform at a high temperature has characteristics shown by a thin line therein. For this reason, values that characterize the second peak point Bp (Bm) also change relative to temperature.

As such, attention is focused in the temperature detection operation (B) on the peak value (i.e., crest value) of the second peak point Bp (Bm) and the length of time from the beginning of the time period Ta (Tc) to the second peak point (peak arrival time) as the values that characterize the second peak point Bp (Bm). In addition, as in the electric current detection operation (A) described above, attention is focused in the detection operation (B) on a current saturation value in addition to the peak value of the second peak point and the length of time from the beginning of the time period to the second peak point, or one or more of these characteristics.

In FIG. 7, I_{LC}(+) denotes the peak value of the second peak point Bp in the time period Ta. The length of time from the beginning of the time period Ta to the second peak point Bp (second-peak arrival time) is shown as ts(+). The current saturation value for the time period Ta is shown as Isat(+). In like manner, in FIG. 7, I_{LC}(−) denotes the peak value of the second peak point Bm in the time period Tc. The length of time from the beginning of the time period Tc to the second peak point Bm (second-peak arrival time) is shown as ts(−). The current saturation value for the time period Tc is shown as Isat(−).

These values have the following relationship with temperature: As temperature increases, the peak value of the second peak point increases. As temperature increases, the peak arrival time becomes shorter. As temperature increases, the current saturation value increases.

As previously explained, the temperature output circuit 35 utilizes characteristic information in the temperature detection operation (A) to calculate temperature information based on a current saturation value. In the temperature detection operation (B), the relationship between current saturation values and temperature values is pre-stored in a table. The temperature output circuit 35 looks up the table to find the temperature of the liquid crystal layer 105 based on the detected current saturation value and then outputs the temperature information.

Or, the temperature output circuit 35 may utilize characteristic information as in the temperature detection operation (A) in order to calculate the temperature based on the current saturation value. As explained above for the current saturation value, the relationship between the peak values of the second peak point and temperature values is pre-stored in a table. The temperature output circuit 35 looks up the table to find the temperature of the liquid crystal layer 105 based on the detected peak value of the second peak point and then outputs the temperature information.

The same applies for peak arrival time. That is, the relationship between peak arrival time and temperature is pre-stored in a table. The temperature output circuit 35 looks up the table to find the temperature of the liquid crystal layer 105 based on the detected peak arrival time and then outputs the temperature information.

FIGS. 8A-8C are flowcharts that schematically illustrate examples of the processing flow of the temperature detection operation (B) according to the present embodiment of the invention. FIG. 8A is a flowchart of operation for detecting a current saturation value and outputting temperature information on the basis thereof. FIG. 8B is a flowchart of operation for detecting the peak value of the second peak point and outputting temperature information on the basis thereof. FIG. 8C is a flowchart of operation for detecting second-peak arrival time and outputting temperature information on the basis thereof. The upper part of each of FIGS. 8A, 8B, and 8C shows operation for detecting a value of either one of positive and negative polarities, which is assumed to be positive polarity in this example, and outputting temperature information on the basis thereof. The lower part of each of FIGS. 8A, 8B, and 8C shows operation for detecting values of both of positive and negative polarities and outputting temperature information on the basis thereof.

The operation shown in the upper part of FIG. 8A is explained below. At step a11, the temperature output circuit 35 takes, out of digital values outputted from the A/D conversion circuit 34 after A/D conversion thereat, a value sampled at a point in time immediately before the end of the time period Ta (i.e., at a point in time immediately before the start of the time period Tb) as the current saturation value Isat(+). In the next step a14, the temperature output circuit 35 looks up a table to convert the current saturation value Isat(+) into temperature information and then outputs the temperature information. When the temperature information is outputted, a table for a temperature range within which the temperature (temperature information) outputted from the temperature output circuit 35 falls is selected at the lookup table 32.

Next, the operation shown in the upper part of FIG. 8B is explained below. In a step b11, the temperature output circuit 35 locates the second peak point Bp appearing after the first peak point Ap in the time period Ta out of digital values outputted from the A/D conversion circuit 34. The temperature output circuit 35 takes the crest value thereof as the peak value I_{LC}(+). Then, in a step b14, the temperature output circuit 35 looks up a table to convert the peak value I_{LC}(+) into temperature information and then outputs the temperature information. The temperature output circuit 35 can locate the second peak point Bp by finding a point at which the level of an electric current takes a downward turn after the start of the time period Ta.

Next, the operation shown in the upper part of FIG. 8C is explained below. In a step c11, the temperature output circuit 35 measures the length of time from the beginning of the time period Ta to the second peak point Bp, that is, the second-peak arrival time ts(+). Then, in a step c14, the temperature output circuit 35 looks up a table to convert the arrival time ts(+) into temperature information and then outputs the temperature information.

As explained above, with the temperature detection operation (B), it is possible to output information on the temperature of the liquid crystal layer 105 on the basis of the peak value of the second peak point or the second-peak arrival time. Or, the temperature information can be outputted on the basis of the current saturation value. In the above explanation, it is assumed that a value is detected for the positive polarity. A value may also be detected for the negative polarity.

The procedure shown in the lower part of FIG. 8A is explained below. In a step a12 that follows the step a11, which is the same as the step a11 of the upper part thereof, the temperature output circuit 35 takes, out of digital values outputted from the A/D conversion circuit 34 after the A/D conversion process, a value sampled at a point in time immediately before the end of the time period Tc (i.e., at a point in time immediately before the start of the time period Td) as the current saturation value Isat(−). In the next step a13, an average of the absolute values of the current saturation values Isat(+) and Isat(−) is calculated. Then, in the next step a14, the temperature output circuit 35 looks up a table to convert the average value into temperature information, and then outputs the temperature information.

The procedure shown in the lower part of FIG. 8B is as follows. In a step b12 that follows the step b11, which is the same as the step b11 of the upper part thereof, the temperature output circuit 35 locates the second peak point Bm appearing after the first peak point Am in the time period Tc out of digital values outputted from the A/D conversion circuit 34. The temperature output circuit 35 takes the crest value thereof as the peak value I_{LC}(−). In the next step b13, an average of the absolute values of the peak values I_{LC}(+) and I_{LC}(−) is calculated. Then, in the next step b14, the temperature output circuit 35 looks up a table to convert the average value into temperature information, and then outputs the temperature information. The temperature output circuit 35 can locate the second peak point Bm by finding a point at which the level of an electric current takes an upward turn after the start of the time period Tc.

The procedure shown in the lower part of FIG. 8C is as follows. In a step c12 that follows the step c11, which is the same as the step c11 of the upper part thereof, the temperature output circuit 35 measures the length of time from the beginning of the time period Tc to the second peak point Bm as the second-peak arrival time ts(−). In the next step c13, an average of the absolute values of the arrival times ts(+) and ts(−) is calculated. Then, in the next step c14, the temperature output circuit 35 looks up a table to convert the average value into temperature information, and then outputs the temperature information. When a value of either polarity is used, there is a possibility of outputting a result that is not accurate in a case where the value of positive polarity and a value of negative polarity are not balanced with each other. With the use of an average of a positive value and a negative value, it is possible to detect the temperature of the liquid crystal layer 105 with greater accuracy. Though it is explained above that a value of positive polarity and a value of negative polarity are detected once, each value may be detected twice or more. The temperature of the liquid crystal layer 105 to be outputted may be found based on the average of these values.

As explained above, with the temperature detection operation (B), it is possible to detect the temperature of the liquid crystal layer 105 based on one characteristic selected from the current saturation value, the peak value of the second peak point, and the second-peak arrival time. It is inferred that the accuracy of measurement when the peak value of the second peak point is used is greater than the accuracy of measurement when the second-peak arrival time is used. In addition, it is inferred that the accuracy of measurement when the second-peak arrival time is used is greater than the accuracy of measurement when the current saturation value is used. In view of the above, for example, temperature values may be found based on these three values, followed by the weighting of the temperature values in the order of measurement accuracy.

Whichever temperature detection operation (A or B) is adopted, information on the temperature of a liquid crystal layer is outputted based on the waveform of a common current. Therefore, the first embodiment of the invention eliminates the need for a temperature sensor in the area of the liquid crystal panel 100. In addition, the resistance element 60 may be, for example, included in or provided on the FPC as explained earlier since the resistance element 60 has only to be provided somewhere on the electric supply line 70. Therefore, there is almost no restriction when mounting the resistance element 60.

Moreover, since the temperature of a liquid crystal layer is found based on the waveform of a common current that reflects the temperature, it is possible to perform temperature detection with greater accuracy in comparison with a case where a temperature sensor is provided in the area of the liquid crystal panel 100.

The following description is found in the patent document which was previously mentioned, JP-A-9-96796, which is an example of the current state of the art. An alternating-current power supply is connected to an auxiliary capacitance (storage capacitance) electrode. An electric current that flows in the auxiliary capacitance electrode is measured with the use of an alternating-current ammeter. The resistance value of the auxiliary capacitance electrode is calculated. Then, the temperature of a liquid crystal panel is calculated based on the resistance value. However, due to the nature of an electrode, the resistance value of the auxiliary capacitance electrode is almost zero. Therefore, even when the resistance value of the auxiliary capacitance electrode changes depending on temperature, the change in resistance is relatively small in comparison with the internal resistance of the alternating-current ammeter. For this reason, it is inferred that an actual measurement result contains a substantial measurement error. In addition, when the alternating-current power supply for resistance measurement is connected to the auxiliary capacitance electrode, it is necessary to increase frequency (by 1 to 2 MHz) so as not to cause the response of a liquid crystal layer. Since at least twice the sampling frequency is required in order to measure an electric current having such high frequency, it is inevitable that the configuration of the alternating-current ammeter is less simple.

In contrast, in the present embodiment of the invention, the resistance element 60 converts an electric current that flows through the electric supply line 70 through which the voltage LCcom is supplied into a voltage for detection. Therefore, a measurement error is small. In addition, it is not necessary to provide a complex alternating-current ammeter for high frequency.

In the first embodiment of the invention, the sum of the values of an electric current that flow in all of the liquid crystal elements 120 is detected in electric current detection operation. The exemplary configuration described above may also be modified as follows. For example, dummy scanning lines and dummy pixels may be provided at an area that is outside the display area 101 but inside the sealing material 152. Throughout the vertical flyback time period Fb, a selection voltage may be applied to the dummy scanning lines.

On the other hand, for example, the voltage Vb(+), Vb(−) corresponding to the black level is supplied as the level of data signals to the data lines 114 therein. In the vertical flyback time period Fb, the display area 101 is in a held state with the pixel electrodes 118 being not electrically connected to anywhere. Accordingly, if the off-leak of the TFTs 116 is negligibly small, no electric current flows in the liquid crystal elements 120 that are provided in the display area 101. Therefore, an electric current flows only in the liquid crystal elements 120 corresponding to the dummy scanning lines. Since an electric current that flows through the resistance element 60 is limited to one that flows in the dummy scanning lines, the amount of the current is small; however, it is possible to detect an electric current without affecting a display picture that appears in the display area 101 during display operation.

### Second Embodiment

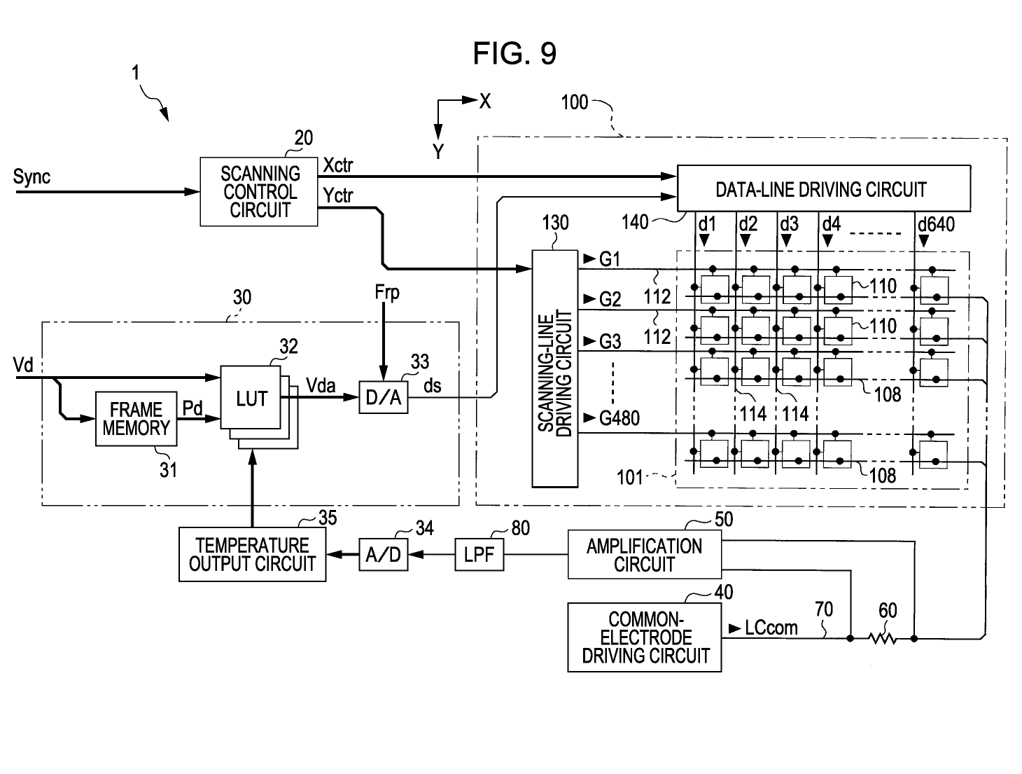

Next, a second embodiment of the invention will be explained below. FIG. 9 is a diagram that schematically illustrates an example of the configuration of a liquid crystal display device according to the second embodiment of the invention. The liquid crystal display device illustrated in FIG. 9 is different in terms of configuration from the liquid crystal display device according to the first embodiment of the invention, which is illustrated in FIG. 1, in that the former is provided with a low pass filter (LPF) 80. The LPF 80 is provided as an upstream device as viewed from the A/D conversion circuit 34 (i.e., at the input side of the A/D conversion circuit 34). The LPF 80 selectively passes the low frequency component of a signal outputted from the amplification circuit 50.

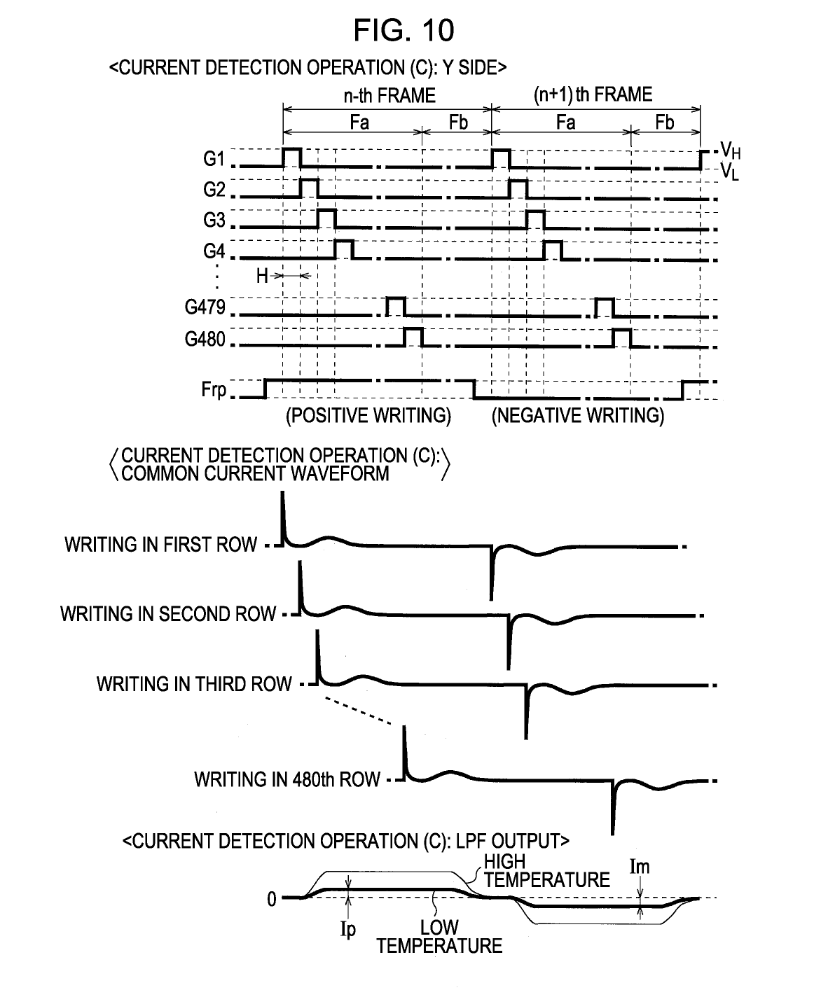

In addition, the liquid crystal display device illustrated in FIG. 9 is different in terms of operation from the liquid crystal display device illustrated in FIG. 1 in that, in temperature detection operation (C) according to the second embodiment of the invention, the scanning-line driving circuit 130 performs line-sequential driving operation for sequentially selecting scanning lines in the same manner as done in a display mode and as shown in FIG. 10, unlike the temperature detection operation (A) and (B) according to the first embodiment of the invention. When a line-sequential driving scheme is adopted, the waveform of a common current appears as the superimposition of electric-current waveforms that appear upon the sequential selection of respective rows as illustrated in the drawing, that is, the superimposition of electric-current waveforms that respectively appear when the level of the scanning signals G1-G480 are sequentially set at the H level. The component of an instantaneous carrying current included in the superimposed waveform, which corresponds to a first peak point, has a high frequency. Therefore, it is filtered out at the LPF 80. As a result, an integral of the peak values of the second peak points, which include a low frequency component, is outputted from the LPF 80 as illustrated in FIG. 10. As explained earlier, the absolute peak value of the second peak point increases as temperature increases.

The temperature output circuit 35 calculates either the amplitude Ip of the integral component for the second peak points attributable to the application of a positive voltage or the amplitude Im of the integral component for the second peak points attributable to the application of a negative voltage from digital data converted from an output signal of the LPF 80. A relationship between the value and temperature is pre-stored in a table. The temperature output circuit 35 looks up the table to find temperature on the basis thereof and then outputs temperature information. Or, the temperature output circuit 35 calculates an average of the absolute values of the two, looks up the table to find temperature on the basis thereof, and then outputs temperature information.

The temperature detection operation (C) according to the second embodiment of the invention has an advantage over the temperature detection operation (B) according to the first embodiment of the invention in that, firstly, it is not necessary to change the driving mode of the scanning-line driving circuit 130 from a display operation mode, and secondly, it is not necessary to perform waveform processing to locate the second peak point and find the peak value thereof.

### Third Embodiment

Next, a third embodiment of the invention will be explained. In the foregoing first and second embodiments of the invention, the lookup table 32, which is used for compensating the responsiveness of liquid crystal, is switched over depending on information on detected temperature. However, control depending on information on detected temperature is not limited to the above examples. As another example of control depending on information on detected temperature is illustrated in the third embodiment of the invention. In the third embodiment of the invention, the system is controlled to reduce a change in a transmission factor when temperature information changes.

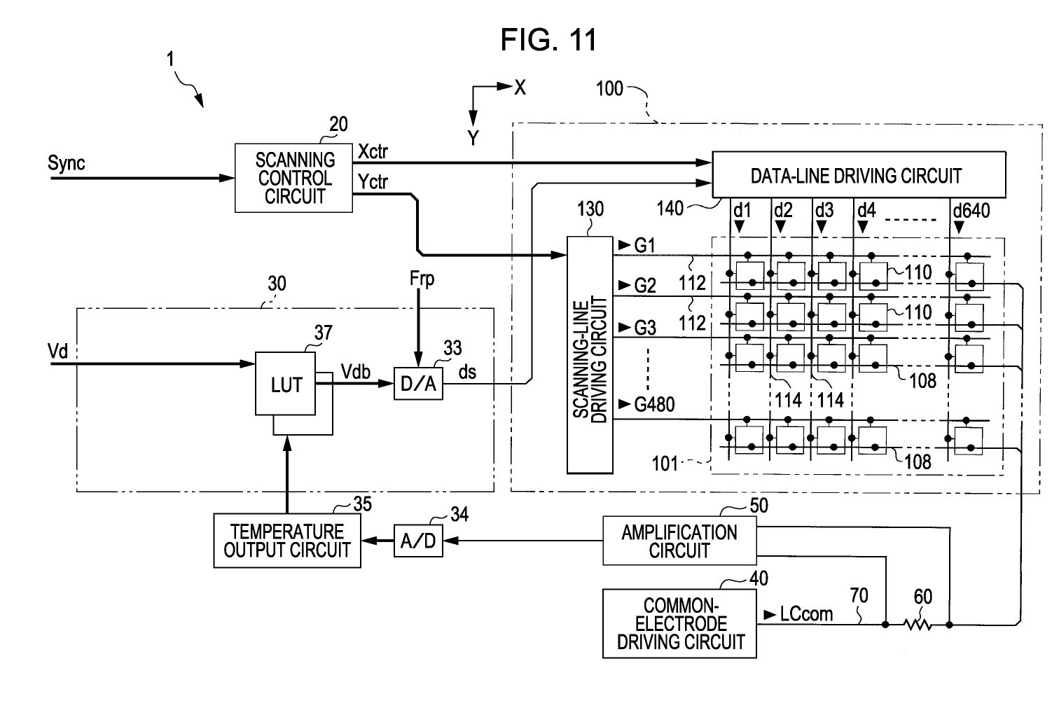

FIG. 11 is a diagram that schematically illustrates an example of the configuration of a liquid crystal display device according to the third embodiment of the invention. The liquid crystal display device illustrated in FIG. 11 is different in terms of configuration from the liquid crystal display device according to the first embodiment of the invention, which is illustrated in FIG. 1, in that, firstly, the former is not provided with the frame memory 31, and secondly, the former is provided with a lookup table 37 as a substitute for the lookup table 32. The above points of difference are focused in the following description.

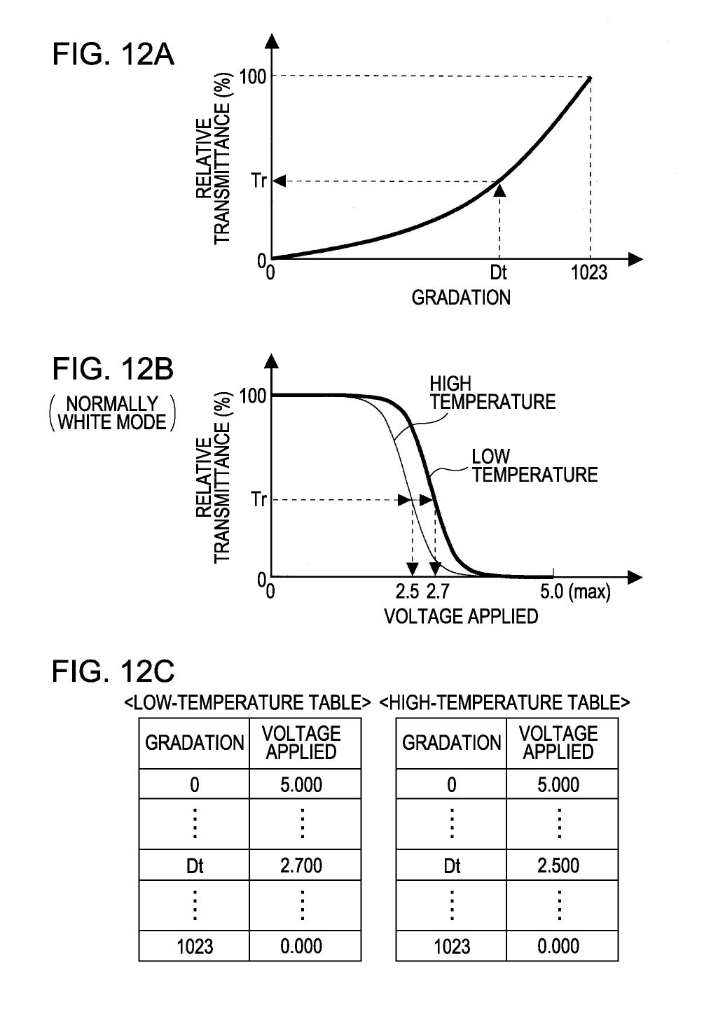

A relationship between a gradation level that is specified by the video signal Vd and the transmission factor of the liquid crystal element 120 is nonlinear. As illustrated in FIG. 12A, with a human visual sensitivity taken into consideration, the relationship has curved characteristics whose gamma coefficient is 2.2. On the other hand, in a normally white mode, a relationship between a voltage (V) that is applied to the liquid crystal element 120 and a transmission factor (T) (i.e., so-called V−T characteristics) is as illustrated in FIG. 12B.

Accordingly, the following approach is taken for voltage application. As a first step, a transmission factor that corresponds to a gradation level specified by the video signal Vd is found with reference to the gamma characteristic curve illustrated in FIG. 12A. As a second step, a voltage that should be applied so as to obtain the transmission factor is found with reference to the V−T characteristics illustrated in FIG. 12B. Then, the voltage is applied to a liquid crystal element.

When the V−T characteristics have a characteristic curve shown by a thick line in the drawing in a low temperature state, the V−T characteristics have a characteristic curve shown by a thin line in a high temperature state. That is, as temperature increases, the transmission factor changes at a lower voltage range. In view of the above, in the present embodiment of the invention, for example, two lookup tables, that is, a low temperature range lookup table and a high temperature range lookup table, are prepared as the lookup table 37 in which a relationship between a gradation level and a voltage that should be applied is written as illustrated in FIG. 12C. One lookup table is selected depending on temperature information outputted from the temperature output circuit 35.

Accordingly, in the illustrated example of FIGS. 12A-C, when the gradation level specified by the video signal Vd is Dt, it is judged as a low temperature state if the temperature information outputted from the temperature output circuit 35 is not larger than a threshold value. In this case, a video signal Vdb for setting a voltage applied to a liquid crystal element at 2.7V is outputted. It is judged as being in a high temperature state if the temperature information outputted from the temperature output circuit 35 is larger than the threshold value. In this case, the video signal Vdb for setting the voltage applied to the liquid crystal element at 2.5V is outputted. The video signal Vdb is converted into the data signal ds whose level is higher or lower than the reference voltage Vc by a voltage level specified by the A/D conversion circuit 34. By this means, even when the actual transmission factor of the liquid crystal element 120 transitions from a low temperate state to a high temperature state, it is possible to avoid a change from the transmission factor specified by the gradation level Dt.

It is explained above that two lookup tables, that is, a low temperature range lookup table and a high temperature range lookup table, are used as the lookup tables 37. However, the number of lookup tables is not limited to two. Three or more lookup tables may be prepared. In the illustrated example of FIGS. 12A-12C, the video signal Vd has 10 bits. The gradation level is specified in 1024 steps from “0” inclusive to “1023” inclusive. However, a voltage applied corresponding to these steps of the gradation level is a mere example. Examples of control depending on obtained temperature information are not limited to the compensation of the responsiveness of liquid crystal and the reduction of a change in a transmission factor. The controlling of the number of revolutions of a fan for cooling the liquid crystal panel 100 is another example thereof.

In each of the foregoing embodiments of the invention, the resistance element 60 that is provided somewhere on the electric supply line 70 converts an electric current that flows in the liquid crystal layer 105 into a voltage. Temperature information is obtained through calculation on the basis of the voltage and is then outputted. However, an element or the like for detecting an electric current is not limited to the resistance element 60. For example, a Hall element or a current transformer may be used to detect an electric current that flows in the liquid crystal layer. With a Hall element provided on the electric supply line 70, or with a current transformer through which the electric supply line 70 goes, it is possible to take out a magnetic field that is generated depending on an electric current that flows in the liquid crystal layer 105 in the form of an electric signal. The level of the electric signal is taken as a value corresponding to the electric current that flows in the liquid crystal layer. Temperature information can be obtained through calculation on the basis of the value.

Furthermore, a normally black mode may be adopted as a substitute for a normally white mode. Needless to say, a reflective liquid crystal display scheme may be adopted as a substitute for a transmissive liquid crystal display scheme.

In each of the foregoing embodiments of the invention, the liquid crystal panel 100 is explained as a vertical electric field liquid crystal panel. However, the scope of the invention is not limited thereto. A horizontal electric field scheme such as fringe field switching (FFS), in-plane switching (IPS), or the like may be adopted. In the structure of a vertical electric field liquid crystal panel, the pixel electrodes 118 are provided on the TFT array substrate 150, whereas the common electrode 108 is provided on the opposite substrate 151. In the structure of a horizontal electric field liquid crystal panel, both the pixel electrodes 118 and the common electrode 108 are provided on the TFT array substrate 150. A second voltage and a first voltage are applied to the pixel electrode 118 and the common electrode 108, respectively, to drive a liquid crystal layer.

### Electronic Apparatus

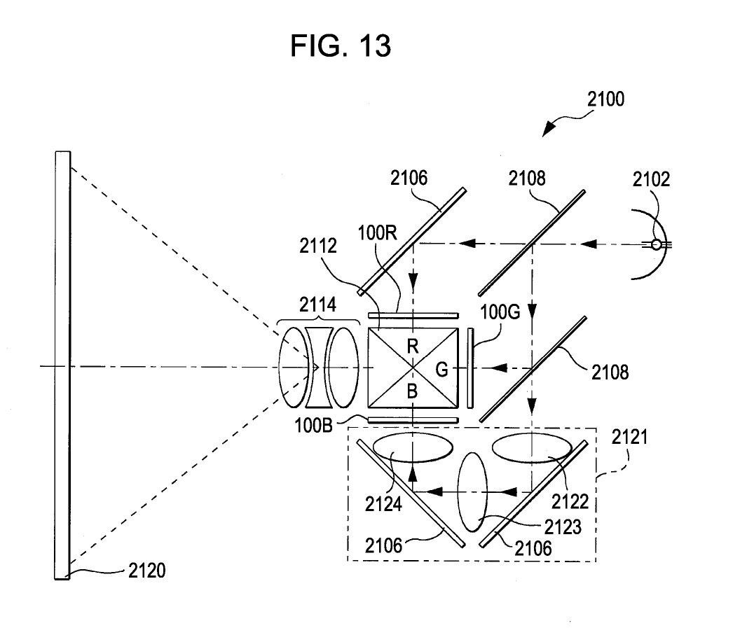

Next, an example of an electronic apparatus to which the liquid crystal display device 1 according to an exemplary embodiment of the invention is applied is explained. FIG. 13 is a plan view that schematically illustrates an example of the configuration of a projector that uses the liquid crystal panel 100 of the liquid crystal display device 1 as a light source. As illustrated in FIG. 13, a lamp unit 2102, which is made of a white light source such as a halogen lamp, is provided in a projector 2100. A beam of projection light that is emitted from the lamp unit 2102 is separated into three primary color components of red (R), green (G), and blue (B) by three mirrors 2106 and two dichroic mirrors 2108 arranged inside the projector 2100. The beams of separated primary color components of R, G, and B are guided to enter corresponding light valves 100R, 100G, and 100B, respectively. The optical path for the B beam is longer than the optical path for the R beam and the optical path for the G beam. Therefore, in order to prevent optical loss, the B beam is guided through a relay lens system 2121, which is made up of an incoming beam lens 2122, a relay lens 2123, and an outgoing beam lens 2124.

In the configuration of the projector 2100, three electro-optical devices, each of which includes the liquid crystal panel 100, are provided for the three primary color components of R, G, and B. An external host circuit supplies a video signal for each of the color components of R, G, and B thereto. The video signal is stored in a frame memory. The configuration of the light valves 100R, 100G, and 100B is the same as that of the liquid crystal panel 100 previously explained. Beams of light modulated by the light valves 100R, 100G, and 100B enter a dichroic prism 2112 from the respective directions, that is, three directions. The R beam and the B beam are refracted at a 90-degree angle at the dichroic prism 2112, whereas the G beam goes straight through the dichroic prism 2112. These color components are combined with one another. As a result, a color image is projected on a screen 2120 through a projection lens 2114.

Light corresponding to one of the primary colors R, G, and B enters into the corresponding one of the light valves 100R, 100G, and 100B because of the presence of the dichroic mirror 100. Therefore, it is not necessary to provide a color filter thereon. A transmission image of the light valve 100R is reflected at the dichroic prism 2112 before projection. A transmission image of the light valve 100B is also reflected at the dichroic prism 2112 before projection. In contrast, a transmission image of the light valve 100G is directly projected. For this reason, the horizontal scanning direction of the light valves 100R and 100B is configured to be opposite to the horizontal scanning direction of the light valve 100G for displaying a mirror reversed image in the horizontal direction.

Besides a projector explained above with reference to FIG. 13, the liquid crystal panel 100 may be used as a light source for, for example, a rear projection television. In addition, the liquid crystal panel 100 can be applied to, for example, an electronic viewfinder (EVF) for a mirror-less lens-replaceable digital camera, a video camera, and the like. Among the variety of electronic apparatuses to which a liquid crystal device according to an aspect of the present invention is applicable are a head-mount display device, a car navigation device, a pager, an electronic personal organizer, an electronic calculator, a word processor, a workstation, a videophone, a POS terminal, a digital still camera, a mobile phone, a touch panel, and so forth. Needless to say, a liquid crystal device according to an aspect of the invention is applicable to the above various electronic apparatuses without any limitation to those enumerated above.

What is claimed is:

1. A liquid crystal device comprising:
a first substrate and a second substrate that are provided opposite to each other with a liquid crystal layer being disposed therebetween;
a first electrode and a second electrode provided for each intersection of a plurality of scanning lines and a plurality of data lines, the first electrode and the second electrode driving the liquid crystal layer;
a first supply circuit that supplies a first voltage to the first electrode through an electric supply line;
a second supply circuit that supplies a second voltage to the second electrode through at least one of the plurality of data lines, the second voltage being different from the first voltage;
an electric current detection element that detects a value corresponding to an electric current that flows in the liquid crystal layer when the first voltage and the second voltage are applied; and
a temperature information output circuit that outputs temperature information of the liquid crystal layer based on the value corresponding to the electric current,
wherein the temperature information output circuit converts a peak value of a second peak that appears in a detected waveform for the value corresponding to the electric current when the first voltage and the second voltage are applied, which are detected by the electric current detection element, into the temperature information of the liquid crystal layer.

2. The liquid crystal device according to claim 1, wherein the temperature information output circuit has a table in which a relationship between a value corresponding to the electric current and the temperature is pre-stored, and wherein the temperature information output circuit looks up the table to convert the value corresponding to the electric current into the temperature information of the liquid crystal layer.

3. A temperature detection method that is used by the liquid crystal device of claim 1, the temperature detection method comprising:
applying the first voltage to the first electrode through the electric supply line;
applying the second voltage to the second electrode through at least one of the plurality of data lines; and
converting the peak value of the second peak that appears in the detected waveform for the value corresponding to the electric current when the first voltage and the second voltage are applied, which are detected by the electric current detection element, into the temperature information of the liquid crystal layer.

4. An electronic apparatus that is provided with the liquid crystal device according to claim 1.
